(19) United States
(12) Patent Application Publication
(10) Pub. No.: US 2020/0225363 A1
(43) Pub. Date: Jul. 16, 2020

(54) MAINTAINING VEHICLE POSITION ACCURACY

(71) Applicant: GM GLOBAL TECHNOLOGY OPERATIONS LLC, Detroit, MI (US)

(72) Inventors: Soheil Samii, Royal Oak, MI (US); Michael E. Potts, Lenox Township, MI (US); David A. Bodenmiller, Milford, MI (US); Curtis L. Hay, West Bloomfield, MI (US); Steven R. Croyle, Bingham Farms, MI (US)

(21) Appl. No.: 16/249,268

(22) Filed: Jan. 16, 2019

(51) Int. Cl. G01S 19/41; G05D 1/02; G01S 19/42

(52) U.S. Cl. CPC G01S 19/41; G05D 1/0276; G01C 21/26; G05D 2201/0213; G01S 19/423

(57) ABSTRACT

Embodiments include methods, systems and computer readable storage medium for a method for making temporal corrections to position data received a plurality of components. The method includes receiving, by a processor, vehicle location data and a time stamp associated with the vehicle location data from one or more components. The method further includes calculating, by the processor, a time difference between the time stamp and a current time received from the one or more components. The method further includes determining, by the processor, a time offset using the time difference and a distance travelled between the time stamp and an occurrence of the determination for each of the one or more components. The method further includes providing, by the processor, a corrected vehicle location using the time offset for each of the one or more component.

### INTRODUCTION

The subject disclosure relates to vehicle localization, and more specifically to implementing precision vehicle localization using a time synchronization arrangement.

Autonomous vehicles have the ability to operate and navigate without human input. Autonomous vehicles, as well as some non-autonomous vehicles, use sensors, such as cameras, radar, LIDAR, global positioning systems, and computer vision, to detect the vehicle's surroundings. Advanced computer control systems interpret the sensory input information to identify a vehicle's location, appropriate navigation paths, as well as obstacles and relevant signage. Some autonomous vehicles update map information in real time to remain aware of the autonomous vehicle's location even if conditions change or the vehicle enters an uncharted environment. Autonomous vehicles as well as non-autonomous vehicles increasingly communicate with remote computer systems and with one another using V2X communications—Vehicle-to-Everything, Vehicle-to-Vehicle (V2V), Vehicle-to-Infrastructure (V2I)).

As autonomous vehicles become more sophisticated, having an accurate location of each vehicle on a road network is important. Autonomous vehicles depend on position estimates for each vehicle on the road network to operate in a safe manner. Accordingly, it is be desirable to provide further improvements for maintaining an accurate location of each vehicle on the road network.

### SUMMARY

In one exemplary embodiment, a method for making temporal corrections to position data received a plurality of components is disclosed. The method includes receiving, by a processor, vehicle location data and a time stamp associated with the vehicle location data from one or more components. The method further includes calculating, by the processor, a time difference between the time stamp and a current time received from the one or more components. The method further includes determining, by the processor, a time offset using the time difference and a distance travelled between the time stamp and an occurrence of the determination for each of the one or more components. The method further includes providing, by the processor, a corrected vehicle location using the time offset for each of the one or more components.

In addition to one or more of the features described herein, one or more aspects of the described method display the corrected vehicle location on a vehicle display. Another aspect of the method uses the corrected vehicle location to perform one or more vehicle operations. Another aspect of the method is that the time offset is used to add temporal corrections to the vehicle location data from each of the one or more components. Another aspect of the method is that the temporal corrections are used to maintain longitudinal and lateral precision of the vehicle location data from each of the one or more components. Another aspect of the method is that a time synchronization protocol is used to generate the time stamp and the time offset. Another aspect of the method is that the time synchronization protocol uses an initial reference clock generated by a master controller.

In another exemplary embodiment, a system for making temporal corrections to position data received a plurality of components is disclosed herein. The system includes a vehicle having a memory, a processor coupled to the memory and a plurality of components that provide vehicle location data. The processor associated with the vehicle is operable to receive vehicle location data and a time stamp associated with the vehicle location data from each of the plurality of components. The processor is further operable to calculate a time difference between the time stamp and a current time received from the one or more components. The processor is further operable to determine a time offset using the time difference and a distance travelled between the time stamp and an occurrence of the determination for each of the one or more components. The processor is further operable to provide a corrected vehicle location using the time offset for each of the one or more components.

In yet another exemplary embodiment a computer readable storage medium for performing a method for making temporal corrections to position data received a plurality of components is disclosed herein. The computer readable storage medium includes receiving vehicle location data and a time stamp associated with the vehicle location data from one or more components. The computer readable storage medium further includes calculating a time difference between the time stamp and a current time received from the one or more components. The computer readable storage medium further includes determining a time offset using the time difference and a distance travelled between the time stamp and an occurrence of the determination for each of the one or more components. The computer readable storage medium further includes providing a corrected vehicle location using the time offset for each of the one or more components.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a computing environment according to one or more embodiments;

FIG. 2 is a block diagram illustrating one example of a processing system for practice of the teachings herein;

FIG. 3 depicts a schematic view of an exemplary vehicle control system according to one or more embodiments;

FIG. 4 is a block diagram of vehicle components according to one or more embodiments; and

FIG. 5 depicts a flow diagram of a method for making temporal corrections to position data received by a plurality of components according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

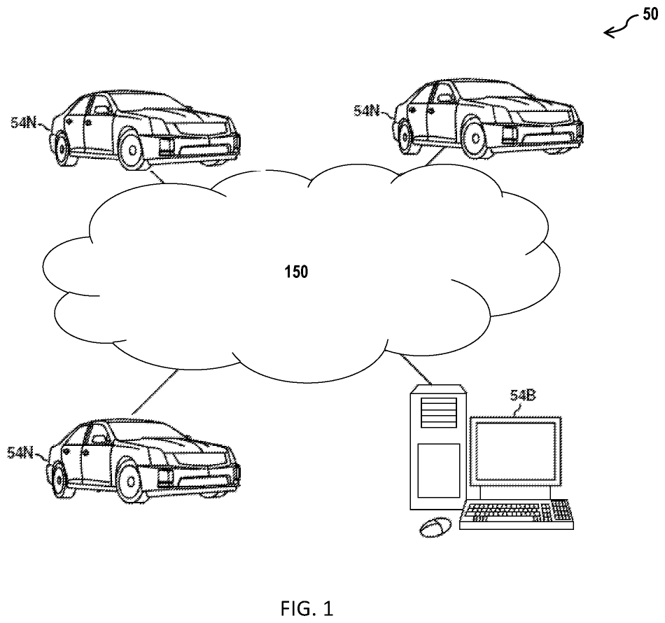

In accordance with an exemplary embodiment, FIG. 1 illustrates a computing environment 50 associated with a system for making temporal corrections to position data received by a plurality of components according to one or more embodiments. As shown, computing environment 50 comprises one or more computing devices, for example, a server/cloud 54B, and/or a vehicle on-board computer system 54N incorporated into each of a plurality of autonomous or non-autonomous vehicles, which are connected via network 150. The one or more computing devices can communicate with one another using network 150.

Network 150 can be, for example, a cellular network, a local area network (LAN), a wide area network (WAN), such as the Internet and WIFI, a dedicated short range communications network (for example, V2V communication (vehicle-to-vehicle), V2X communication (i.e., vehicle-to-everything), V2I communication (vehicle-to-infrastructure), and V2P communication (vehicle-to-pedestrian)), or any combination thereof, and may include wired, wireless, fiber optic, or any other connection. Network 150 can be any combination of connections and protocols that will support communication between server/cloud 54B, and/or the plurality of vehicle on-board computer systems 54N, respectively.

When a cloud is employed instead of a server, server/cloud 54B can serve as a remote compute resource. Server/cloud 54B can be implemented as a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

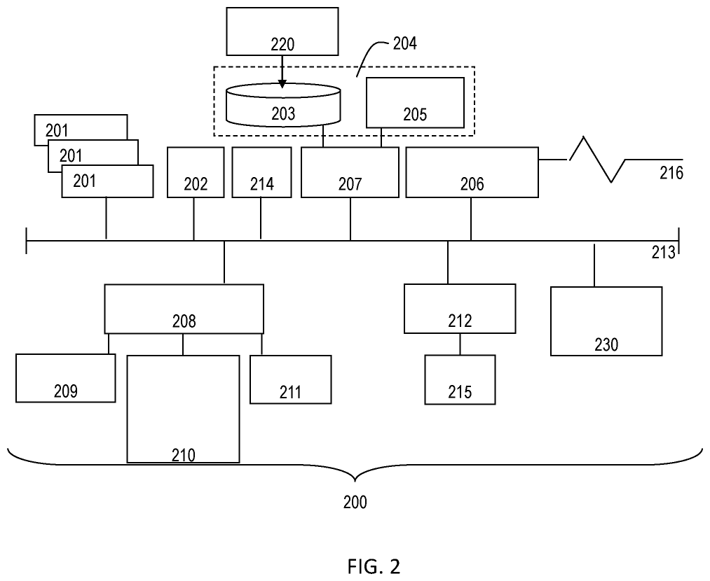

In accordance with an exemplary embodiment, FIG. 2 illustrates a processing system 200 for implementing the teachings herein. The processing system 200 can form at least a portion of the one or more computing devices, such as server/cloud 54B, and/or vehicle on-board computer system 54N. The processing system 200 may include one or more central processing units (processors) 201a , 201b , 201c, etc. (collectively or generically referred to as processor(s) 201). Processors 201 are coupled to system memory 214 and various other components via a system bus 213. Read only memory (ROM) 202 is coupled to the system bus 213 and may include a basic input/output system (BIOS), which controls certain basic functions of the processing system 200.

FIG. 2 further depicts an input/output (I/O) adapter 207 and a network adapter 206 coupled to the system bus 213. I/O adapter 207 may be a small computer system interface (SCSI) adapter that communicates with a hard disk 203 and/or other storage drive 205 or any other similar component. I/O adapter 207, hard disk 203, and other storage drive 205 are collectively referred to herein as mass storage 204. Operating system 220 for execution on the processing system 200 may be stored in mass storage 204. The network adapter 206 interconnects system bus 213 with an outside network 216, which can be network 150, enabling processing system 200 to communicate with other such systems. A screen (e.g., a display monitor) 215 can be connected to system bus 213 by display adaptor 212, which may include a graphics adapter to improve the performance of graphics intensive applications and a video controller. In one embodiment, network adapter 206, I/O adapter 207, and display adapter 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 213 via user interface adapter 208 and display adapter 212. A microphone 209, steering wheel/dashboard controls 210, and speaker 211 can all be interconnected to system bus 213 via user interface adapter 208, which may include, for example, a Super I/O chip integrating multiple device adapters into a single integrated circuit.

The processing system 200 may additionally include a graphics-processing unit 230. Graphics processing unit 230 is a specialized electronic circuit designed to manipulate and alter memory to accelerate the creation of images in a frame buffer intended for output to a display. In general, graphics-processing unit 230 is very efficient at manipulating computer graphics and image processing, and has a highly parallel structure that makes it more effective than general-purpose CPUs for algorithms where processing of large blocks of data is done in parallel.

Thus, as configured in FIG. 2, the processing system 200 includes processing capability in the form of processors 201, storage capability including system memory 214 and mass storage 204, input means such as microphone 209 and steering wheel/dashboard controls 210, and output capability including speaker 211 and display monitor 215. In one embodiment, a portion of system memory 214 and mass storage 204 collectively store an operating system to coordinate the functions of the various components shown in FIG. 2.

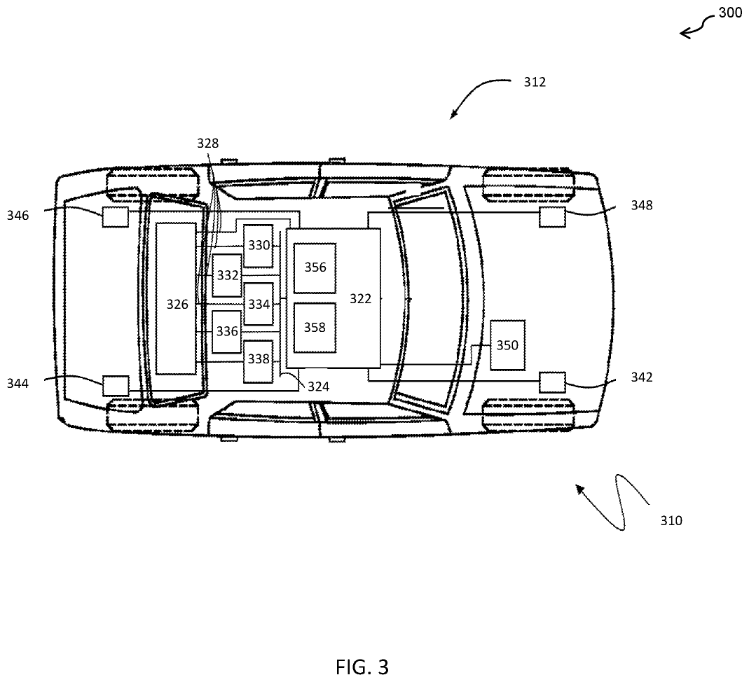

FIG. 3 depicts typical components of a system 300 associated with autonomous or non-autonomous vehicles incorporating the vehicle on-board computer system 54N. An exemplary vehicle control system 312 can be installed on a vehicle 310. The vehicle control system 312 is a distributed network of components which can include a control module 322, a communications bus 324, a vehicle battery 326, one or more additional control modules (330, 332, 334, 336 and 338) and vehicle sensors (342, 344, 346, 348 and 350). The vehicle control system 312 can also include proximity sensors (not shown) and lane marking sensors (not shown).

The vehicle control system 312 can be implemented on fully autonomous vehicle systems, and may be used with any suitably autonomous or semi-autonomous vehicle system (e.g., Levels 0-5 of the Society of Automotive Engineers (SAE) International scale of vehicle automation, e.g., SAE J3016—Taxonomy and Definitions for Terms Related to On-Road Motor Vehicle Automated Driving Systems). Furthermore, vehicle 310 can be a traditional vehicle, a hybrid electric vehicle (HEV), an extended-range electric vehicles (EREV), a battery electrical vehicles (BEV), a motorcycle, a passenger vehicle, a sports utility vehicle (SUV), a cross-over vehicle, a truck, a van, a bus, a recreational vehicle (RVs), etc.

Control module 322 can include a variety of components (e.g., processors, memory, I/O, etc.) described in FIG. 2, and can perform various control and/or communication related functions. The control module 322 can include a memory 356, a processor 358, and a timer (not shown). The memory 356 can store sensor data (e.g., vehicle sensor data, proximity sensor data, and lane marking sensor data) from associated sensors. The memory 356 can also store pertinent characteristics and background information pertaining to the vehicle 310, such as information relating to stopping distances, deceleration limits, maximum braking capability, turning radius, temperature limits, moisture or precipitation limits, driving habits or other driver behavioral data, etc.

The processor 358 can execute instructions for software, firmware, programs, algorithms, scripts, etc., that are stored in memory 356. Control module 322 may be electronically connected to other vehicle devices, modules and systems via suitable vehicle communications (e.g., network 150) and can interact with them when required. The timer may be embodied in hardware, software or a combination thereof

Vehicle 310 can also include a safety control module 330, an engine control module (ECM) 332, an infotainment/entertainment control module 334, a telematics module 336, a GPS module 338 (GLONASS can be used as well), etc. Safety control module 330 can provide various crash or collision sensing, avoidance and/or mitigation type features. For example, the safety control module 330 provides and/or performs collision warnings, lane departure warnings, autonomous or semi-autonomous braking, autonomous or semi-autonomous steering, airbag deployment, active crumple zones, seat belt pre-tensioners or load limiters, and automatic notification to emergency responders in the event of a crash, etc.

The infotainment/entertainment control module 334 can provide a combination of information and entertainment to occupants of the vehicle 310. The information and entertainment can be related to, for example, music, webpages, movies, television programs, videogames and/or other information.

The telematics module 336 can utilize wireless voice and/or data communication over a wireless carrier system (not shown) and via wireless networking (not shown) to enable the vehicle 310 to offer a number of different services including those related to navigation, telephony, emergency assistance, diagnostics, infotainment, etc. The telematics module 336 can also utilize cellular communication according to GSM, W-CDMA, or CDMA standards and wireless communication according to one or more protocols implemented per 3G or 4G standards, or other wireless protocols, such as any of the IEEE 802.11 protocols, WiMAX, or Bluetooth. When used for packet-switched data communication such as TCP/IP, the telematics module 336 can be configured with a static IP address or can be set up to automatically receive a dynamically assigned IP address from another device on the network, such as from a router or from a network address server (e.g., a DHCP server).

The GPS module 338 can receive radio signals from a plurality of GPS satellites (not shown). From these received radio signals, the GPS module 338 can determine a vehicle position that can be used for providing navigation and other position-related services. Navigation information can be presented on a display within the vehicle 310 (not shown) or can be presented verbally such as is done when supplying turn-by-turn navigation. Navigation services can be provided using a dedicated in-vehicle navigation module (which can be part of GPS module 338), or some or all navigation services can be done via the telematics module 336. As such, the position information for the vehicle 310 can be sent to a remote location for purposes of providing the vehicle 310 with navigation maps, map annotations (points of interest, restaurants, etc.), route calculations, and the like.

FIG. 3 further illustrates an exemplary battery powered architecture or configuration in which the various control modules (e.g., control modules 322 and 330-338) are directly or indirectly connected to a vehicle battery 326 via connections 328, so that each control module receives electrical power from the vehicle battery without going through a relay or other type of switch that is connected to an ignition unit.

Vehicle sensors 342-350 can provide the vehicle control system 312 with a variety of vehicle readings and/or other information. The vehicle sensors 342-348 can be speed sensors that generate readings representing a position, velocity and/or acceleration of the vehicle 310. Vehicle sensor 350 can be a vehicle dynamics sensor that provides readings representing vehicle dynamics such as lateral acceleration, yaw rate, etc. The vehicle sensors 342-348 can utilize a variety of different sensors and sensing techniques, including those that use rotational wheel speed, ground speed, accelerator pedal position, gear position, shift lever position, accelerometers, engine speed, engine output, and throttle valve position and inertial measurement unit (IMU) output, etc. Such information may similarly be available through the ECM 332.

IMUs can be devices that use inertial sensors such as accelerometers and gyroscopes to measure how a vehicle, moves. IMUs can be a main component of inertial navigation systems and may measure force, rotational attributes such as pitch, roll, and yaw, to allow the vehicle to navigate.

Although FIG. 3 illustrates a single ECM 332, the vehicle 310 can include multiple ECMs 332. The ECMs 332 can be distributed throughout the vehicle 310 and additionally perform a variety of different vehicle functions. These vehicle functions can be operator-controlled or automated and are referred to herein generally as control tasks. These control tasks can include, for example, controlling vehicle door locks, seat position, cruise control, entertainment system devices (tuners, CD players, etc.), HVAC, intrusion alarms, interior and exterior lighting, electric window position, engine and vehicle system diagnostics, etc. In addition, vehicle position information can be communicated from the GPS module 338 to the ECM 332 via the communications bus 324, which can be a Controller Area Network (CAN) or Ethernet network.

The vehicle sensors 342-348 can be coupled to each of the vehicle's four wheels and separately report the rotational velocity of the four wheels. The vehicle dynamics sensor 350 can be mounted under one of the front seats or at any other suitable location within vehicle 310 that can be used to sense lateral acceleration, yaw rate and other pertinent vehicle dynamics. The speed sensors may operate according to optical, electromagnetic or other technologies, and the other parameters may be derived or calculated from the velocity readings, such as longitudinal or lateral accelerations. The vehicle sensors 342-348 can be used to determine vehicle speed relative to the ground by directing radar, laser and/or other signals towards known stationary objects and analyzing the reflected signals, or by employing feedback from a navigational unit that has GPS and/or telematics capabilities, via a telematics module, that can be used to monitor the location, movement, status and behavior of the vehicle. The vehicle sensors 342-350 can directly or indirectly send information to any of the control modules 330-338, as well as control module 322.

The vehicle control system 312 can utilize the various control modules and vehicle sensors, as well as GPS and/or telematics functionality (components) associated with the vehicle to determine position data (e.g., a local position relative to a map, an exact position relative to lane of a road, vehicle heading, velocity, etc.) of the vehicle 310 relative to a road network or portion thereof, as well as other vehicles and objects along the road network. Additional information from other components within the vehicle (e.g., the IMU, a body control module, transmission, etc.) can also used to determine positon data including heading and rate change information, compass indications, wheel ticks/tire rotation rates (turns), transmission gear indicators, odometer information, yaw rate, etc. Accordingly, the position data generated by each component can be combined/stitched together to increase a location accuracy for the vehicle 310.

The position data can be communicated to each of the control modules and vehicle sensors, GPS and telematics components of the vehicle control system 312. Communicating the position data to each component in the vehicle control system 312 serially, for example, using a CAN bus, can introduce a time delay due to latency (i.e., time delay in vehicle network) and/or jitter (i.e., time delay due to additional network traffic from other components (e.g., steering and automatic braking systems (ABS))). The CAN bus acts as a communications bridge between all of the ECUs, sensors and components within a vehicle.

Accordingly, each component can receive the position data at a different time. The receipt of position data at different times can be problematic because when the vehicle 310 is traveling, it may change position relative to the sent position data. The position change is exacerbated when the vehicle 310 is traveling rapidly and/or as functions that consume the vehicle position as input do so asynchronously. For example, in some instances, network and software latency/jitter can reach up to ˜170 milliseconds (ms). Accordingly, a position error (latitudinal and/or longitudinal) can equal ˜6 meters in ˜170 ms when a vehicle is traveling at 80 mph.

A position error of ˜6 meters can be problematic in autonomous or highly automated vehicle applications, especially in levels 4 and 5 of the SAE J3016 scale of vehicle automation. Accordingly, operation of autonomous or non-autonomous vehicles under such conditions cannot occur reliably.

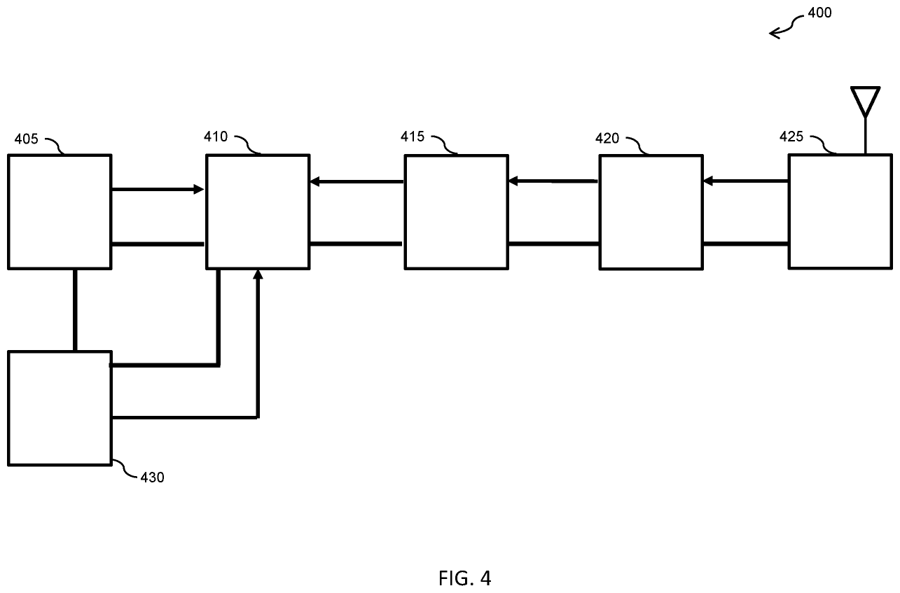

FIG. 4 depicts components or portions thereof of a system 400 associated with each of a plurality of autonomous or non-autonomous vehicles incorporating the vehicle on-board computer system 54N, according to one or more embodiments, which addresses the position error discussed with regards to FIG. 3. System 400 can include a plurality of components (e.g., an inertial measurement unit (IMU) 405, a sensor fusion module 410, a security gateway 415, an infotainment unit 420 a telematics module 425, a mapping application 430, as well as additional components described in FIG. 3.) The IMU 405, infotainment unit 420, and telematics module 425 can operate in a manner similar to the IMU, infotainment/entertainment and telematics modules described in FIG. 3, respectively.

The mapping application 430 can be a high-definition map of a road network or portion thereof. The high-definition map can provide a representation of the road network, including roads and road attributes such as lane models, traffic signs, road fixtures, lane geometry, etc., which can be used for high-precision localization of vehicles, environment perception, planning and decision making, as well as real-time navigation of autonomous and/or non-autonomous vehicles. The mapping application 430 can also use the location data provided by the telematics module 425 to provide a location of the vehicle in relation to the high-definition map. The security gateway 415 can connect the different components of system 400 in a secure manner (i.e., govern and differentiate between legitimate and non-legitimate communications between components).

The sensor fusion module 410 can be used to merge data from multiple components and/or sensors (e.g., control modules 322, 330-338 and vehicle sensors 342-350) to achieve additional insight into the operation of a vehicle within the road network and surrounding environment that cannot be achieved using data from each component or sensor individually. The sensor fusion module 410 can utilize a probabilistic approach using statistical inference from multiple observations, e.g. a Kalman filter. Accordingly, the sensor fusion module 410 can merge/stitch location data, motion data and map data provided by the IMU 405, the telematics module and mapping application 430 to perceive the environment around the vehicle more accurately.

In addition to location data, motion data and map data being exchanged between the components of system 400, each component can utilize a network time synchronization protocol and time stamp produced by a respective component when position data is communicated among ECUs, as well as the IMU 405, the sensor fusion module 410, the security gateway 415, the infotainment unit 420, the telematics module 425 and the mapping application 430 of system 400 in order to address latency and/or jitter amongst the components. The time synchronization protocol can be based on an initial reference clock generated by a GPS clock associated with the telematics module 425 (i.e., master controller) upon receipt of vehicle location information from GPS satellites.

Moreover, the initial reference can also be a local clock of a master ECU. Accordingly, all components in a vehicle network participating in the time synchronization protocol can have a common understanding of time (although not related to an absolute time source) and can therefore be able to understand time stamps received from any other component. Accordingly, precise vehicle positioning as described herein does not require the initial reference clock to be generated by a GPS clock; it is sufficient that the reference clock is that of a master component. Time stamps can be associated with piece of data generated the ECUs, the IMU 405, the sensor fusion module 410, the security gateway 415, the infotainment unit 420, the telematics module 425 and the mapping application 430, used to determine a vehicle location.

The network time synchronization protocol can be implemented using a predetermined protocol, for example, IEEE 802.1AS—Timing and Synchronization protocol. Additionally, each component can utilize multiple network time synchronization protocols and/or time stamps, which can be configured at runtime to carry time synchronization frames in the event an original network time synchronization protocol and/or time stamp transfer fails.

The initial reference clock and time stamp for data used to determine vehicle location allows the components of system 400 to make temporal corrections at runtime, which can be used to accurately interpret the vehicle position. The initial reference clock and time stamp can be used to calculate one or more time offset variances for data exchanges (e.g. a hop-to-hop data exchange) between or amongst the components of system 400. For example, a time offset 1 (e.g., 50 ms) can be generated when location data is exchanged between the telematics module 425 and the infotainment unit 420. A time offset 2 can be generated when location data is exchanged between the infotainment unit 420 and the security gateway 415. A time offset 3 can be generated when location data is exchanged between the security gateway 415 and the sensor fusion module 410. A time offset 4 can be generated when map data is exchanged between the mapping application 430 and the sensor fusion module 410. A time offset 5 (e.g., 10 ms) can be generated when motion data is exchanged between the IMU 405 and the sensor fusion module 410. A time offset 6 can be generated when data is exchanged between the IMU 405 and the mapping application 430. The time-offset variances associated with data generated by each component of system 400 are all in reference to a common clock and can be used to synchronize data exchanged between components that will be combined/stitched together to determine a vehicle location. Accordingly, the vehicle position can accurately be maintained amongst the components of the vehicle. Without such a time stamping method, it is very difficult to maintain the vehicle location accuracy because of varying network latency at runtime resulting from one periodic execution to another.

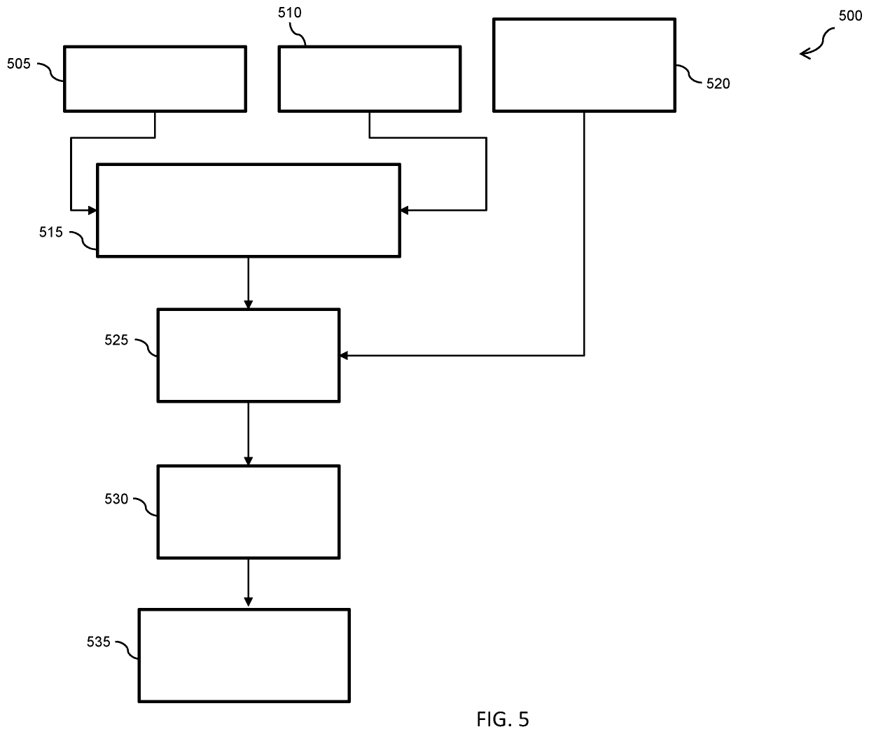

FIG. 5 depicts a flow diagram of a method 500 for implementing a method for making temporal corrections to position data received by a plurality of components according to one or more embodiments. At blocks 505 and 510, a time stamp and respective vehicle location data (e.g., GPS data, yaw rate, compass, etc.) can be received by a computer system, (e.g., the vehicle on-board computer system 54N) from one or more vehicle components. At block 515, the vehicle on-board computer system 54N can calculate a time difference between a current time and the time associated with the time stamp.

At block 520, the vehicle on-board computer system 54N can determine a distance traveled by the vehicle since the time stamp was generated by each of the one or more vehicle components. At block 525, the vehicle on-board computer system 54N can utilize the calculated time difference and the determined distance traveled to determine a time offset variance. Each time-offset variance can be in relation to the vehicle location data generated by a given component of the vehicle at block 510. At block 530, the vehicle on-board computer system 54N can calculate a corrected position location using time offset variances associated with vehicle location data generated by components of the vehicle.

At block 535, the corrected position location can be used by the vehicle on-board computer system 54N to more accurately reflect the location of the vehicle displayed on a local map stored by the vehicle. Moreover, the corrected position location can be used by the vehicle on-board computer system 54N to control one or more autonomous/non-autonomous functions (e.g., navigation, lane changes, turns, speed, braking, etc.) related to operating the vehicle.

Accordingly, the embodiments disclosed herein describe a system that can utilize a network time synchronization protocol to time stamp and maintain vehicle position precision throughout the network. The network time synchronization protocol can be used to provide temporal corrections in real time, which can be used to maintain longitudinal and lateral precision. The temporal corrections are used to address latency and/or jitter that can occur with a vehicle network.

Technical effects and benefits of the disclosed embodiments include, but are not limited to mitigating a deterioration of vehicle location data accuracy due to latency and/or jitter. In addition, autonomous and non-autonomous vehicle employing the disclosed embodiments operate with increased safety because vehicle location data accuracy is maintained while traversing a road network.

The present disclosure may be a system, a method, and/or a computer readable storage medium. The computer readable storage medium may include computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a mechanically encoded device and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for making temporal corrections to position data received by a plurality of components, the method comprising:
receiving, by a processor, vehicle location data and a time stamp associated with the vehicle location data from one or more components;
calculating, by the processor, a time difference between the time stamp and a current time received from the one or more components;
determining, by the processor, a time offset using the time difference and a distance travelled between the time stamp and an occurrence of the determination for each of the one or more components; and
providing, by the processor, a corrected vehicle location using the time offset for each of the one or more components.

2. The method of claim 1 further comprising displaying the corrected vehicle location on a vehicle display.

3. The method of claim 1 further comprising using the corrected vehicle location to perform one or more vehicle operations.

4. The method of claim 1, wherein the time offset is used to add temporal corrections to the vehicle location data from each of the one or more components.

5. The method of claim 4, wherein the temporal corrections are used to maintain longitudinal and lateral precision of the vehicle location data from each of the one or more components.

6. The method of claim 1, wherein a time synchronization protocol is used to generate the time stamp and the time offset.

7. The method of claim 6, wherein the time synchronization protocol uses an initial reference clock generated by a master controller.

8. A system for making temporal corrections to position data received by a plurality of components, the system comprising:
a vehicle; wherein the vehicle comprises:
a memory and a processor coupled to the memory; and
a plurality of components, wherein each component provides vehicle location data;
wherein the processor is operable to:
receive vehicle location data and a time stamp associated with the vehicle location data from each of the plurality of components;
calculate a time difference between the time stamp and a current time received from the one or more components;
determine a time offset using the time difference and a distance travelled between the time stamp and an occurrence of the determination for each of the one or more components; and
provide a corrected vehicle location using the time offset for each of the one or more components.

9. The system of claim 8 further comprising a display that displays the corrected vehicle location.

10. The system of claim 8, wherein the processor is further operable to use the corrected vehicle location to perform one or more vehicle operations.

11. The system of claim 8, wherein the time offset is used to add temporal corrections to the vehicle location data from each of the one or more components.

12. The system of claim 11, wherein the temporal corrections are used to maintain longitudinal and lateral precision of the vehicle location data from each of the one or more components.

13. The system of claim 8, wherein a time synchronization protocol is used to generate the time stamp and the time offset.

14. The system of claim 13, wherein the time synchronization protocol uses an initial reference clock generated by a master controller.

15. A non-transitory computer readable medium having program instructions embodied therewith, the program instructions readable by a processor to cause the processor to perform a method for making temporal corrections to position data received by a plurality of components comprising:
receiving vehicle location data and a time stamp associated with the vehicle location data from one or more components;
calculating a time difference between the time stamp and a current time received from the one or more components;
determining a time offset using the time difference and a distance travelled between the time stamp and an occurrence of the determination for each of the one or more components; and
providing a corrected vehicle location using the time offset for each of the one or more components.

16. The computer readable storage medium of claim 15 further comprising using the corrected vehicle location to perform one or more vehicle operations.

17. The computer readable storage medium of claim 15, wherein the time offset is used to add temporal corrections to the vehicle location data from each of the one or more components.

18. The computer readable storage medium of claim 17, wherein the temporal corrections are used to maintain longitudinal and lateral precision of the vehicle location data from each of the one or more components.

19. The computer readable storage medium of claim 15, wherein a time synchronization protocol is used to generate the time stamp and the time offset.

20. The computer readable storage medium of claim 19, wherein the time synchronization protocol uses an initial reference clock generated by a master controller.
